(19) United States
(12) Patent Application Publication
(10) Pub. No.: US 2002/0194746 A1
(43) Pub. Date: Dec. 26, 2002

(54) Foot dryer apparatus

(76) Inventor: Harold Lancer, Beverly Hills, CA (US)

Correspondence Address: MICHEAL A. PAINTER, ESQ., ISAACMAN, KAUFMAN & PAINTER, 8484 WILSHIRE BOULEVARD, SUITE 850, BEVERLY HILLS, CA, 90211, US

(21) Appl. No.: 09/884,453

(22) Filed: Jun. 19, 2001

Related U.S. Application Data
(63) Continuation-in-part of application No. 29/135,827, filed on Jun. 22, 2001, now abandoned.

(51) Int. Cl. F26B 19/00

(52) U.S. Cl. 34/90

(57) ABSTRACT

A foot dryer includes a cavity. A footrest is disposed in the cavity for supporting a foot of a user. A blower is disposed adjacent the footrest and contained within the rear cavity. The blower delivers air under pressure into the cavity. A liquid dispenser is used to dispense a solution comprising a moisture or fungus inhibiting agent onto the foot inside the cavity. The footrest may activate the blower and/or dispense liquid from a liquid holder.

### RELATED APPLICATION DATA

This is a continuation-in-part of application Ser. No. 29/135,827, filed Jan. 18, 2001, now pending.

### BACKGROUND OF THE INVENTION

The present invention relates to an improved foot dryer useful to evaporate residual moisture from feet and to prevent formation of foot fungus.

There have been many types of apparatus used to evaporate residual moisture from the feet of users and to facilitate the prevention of foot fungus. Various foot dryer designs blow heated air onto the user's foot and disperse fungus inhibiting powder thereon to help prevent the formation of foot fungus, such as athlete's foot. An example of such a design is disclosed in U.S. Pat. No. 6,189,231 entitled “Foot Dryer Apparatus” issued to Lancer, which patent is hereby incorporated by reference as if fully set forth herein.

While previous designs may have been more effective than others in preventing foot fungus formation, an inherent condition of a drying apparatus that dispenses powder is the potential formation of paste on the foot apparatus and dispersion of powder outside the drying cavity. Also, replenishing the powder on such apparatus may be cumbersome and messy.

Therefore, having a new and improved foot dryer that dries feet safely, effectively and can dispense a fungus inhibiting agent while minimizing cleaning maintenance is highly desirable. Moreover, such a new and improved drying device should be able to replenish the fungus inhibiting agent to be applied onto the feet to be dried easily and conveniently.

### SUMMARY OF THE INVENTION

In a first separate aspect of the present invention, an apparatus for drying an object includes dispensing a desired liquid onto the object and drying the object by airflow around the feet.

In a second separate aspect of the present invention, an apparatus for drying an object includes at least one and preferably two or more liquid dispensers. Each dispenser dispensing the same liquid to increase area coverage or dispensing different liquids for gaining the benefit of multiple agents.

In a third separate aspect of the present invention, an apparatus for drying an object includes detachable and replaceable liquid dispenser.

In a fourth separate aspect of the present invention, a foot dryer includes a footrest, a blower and a liquid dispenser. Where the footrest being coupled to activate the blower and/or to dispense liquid from the liquid dispenser.

In a fifth separate aspect of the present invention, a drying apparatus includes an actuator to dispense liquid from a liquid dispenser that may contain the desired liquid.

In a sixth separate aspect of the present invention, a method of drying a foot includes placing the foot on a footrest, generating airflow and dispensing liquid thereon to dry the foot.

A seventh separate aspect of the present invention includes the combination of any of the foregoing aspects.

Other advantages will appear. The invention resides in the apparatus and method of drying an object. The features shown with one embodiment may also be used with other embodiments.

### BRIEF DESCRIPTION OF THE DRAWINGS

FIG. 1A is a perspective view of a foot drying apparatus.

FIG. 1B is a top view of the foot drying apparatus of FIG. 1A.

FIG. 1C is a rear view of the foot drying apparatus of FIG. 1A.

FIG. 1D is a front view of the foot drying apparatus of FIG. 1A.

FIG. 1E is a left side view of the foot drying apparatus of FIG. 1A.

FIG. 1F is a right side view of the foot dryer apparatus of FIG. 1A.

FIG. 2 is an expanded and broken away perspective view of the apparatus of FIG. 1.

FIG. 3 is a cross-sectional side view of the apparatus of FIG. 1 illustrating blower position.

FIG. 4A is an expanded side view of a straight hole perforation configuration.

FIG. 4B is an expanded side view of an inclined hole perforation configuration.

FIG. 5 is a cross-sectional plan view facing the rear of the apparatus of FIG. 1.

FIG. 6 is a cross-sectional side view of the apparatus of FIG. 1 illustrating liquid dispenser position.

FIG. 7 is a cross-sectional side view of the apparatus of FIG. 1 illustrating remote outlet position.

FIG. 8 is a cross-sectional plan view facing the front of the apparatus of FIG. 1 including an alternate footrest support.

FIG. 9 is a cross-sectional side view of the apparatus of FIG. 1 illustrating an integral reservoir embodiment.

FIG. 10 is a perspective view of an alternate foot dryer apparatus.

FIG. 11A is a top view of the foot dryer apparatus of FIG. 10, with the top unit, footrest and actuator arms removed for clarity.

FIG. 11B is a front view of the foot dryer apparatus of FIG. 10.

FIG. 12 is a cross-sectional side view, along section line A-A, of the foot drying apparatus of FIG. 10.

FIG. 13 is a cross-sectional side view, along section line B-B, of the foot drying apparatus of FIG. 10.

FIG. 14 is a top view of the footrest and actuator arms of the foot drying apparatus of FIG. 10.

FIG. 15 is a side view of the footrest and actuator arms of FIG. 14.

FIG. 16 is a partial exploded view of the footrest and actuator arm of the foot drying apparatus of FIG. 10.

FIG. 17 is a partial top view of the footrest of FIG. 16.

FIG. 18 is a side view of an alternate actuator base configuration.

FIG. 19 is a partial exploded view of the actuator arm, liquid dispenser, and well of the foot dryer apparatus of FIG. 10.

FIG. 20 is a perspective view of a liquid dispenser having a circular sector shaped trigger.

FIG. 21 is a partial top view of the footrest and two liquid dispensers illustrating the spray angles.

### DETAILED DESCRIPTION OF THE PREFERRED EMBODIMENT

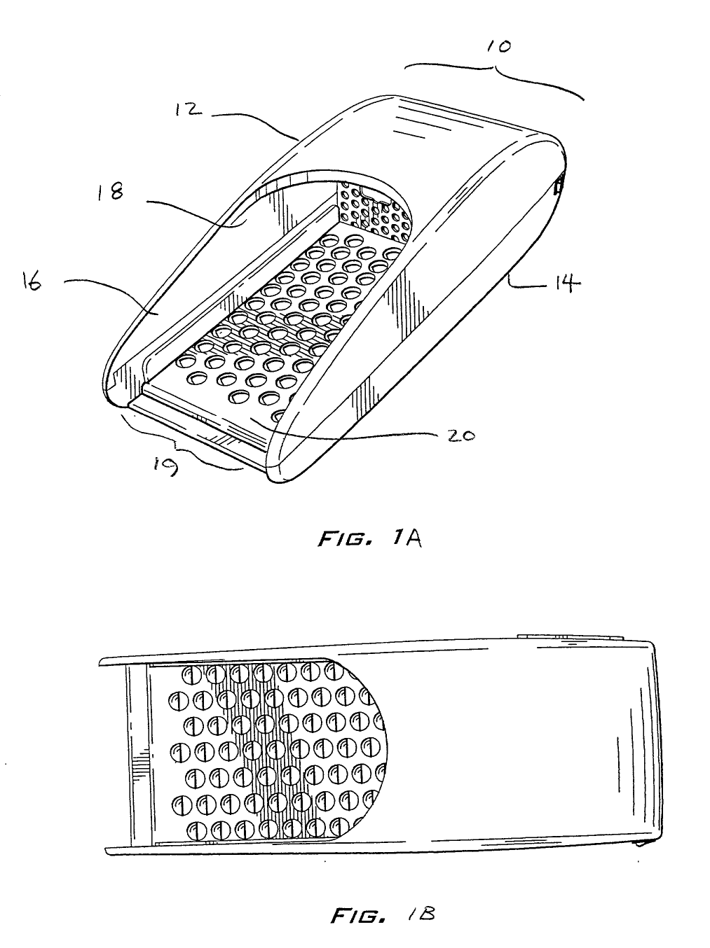

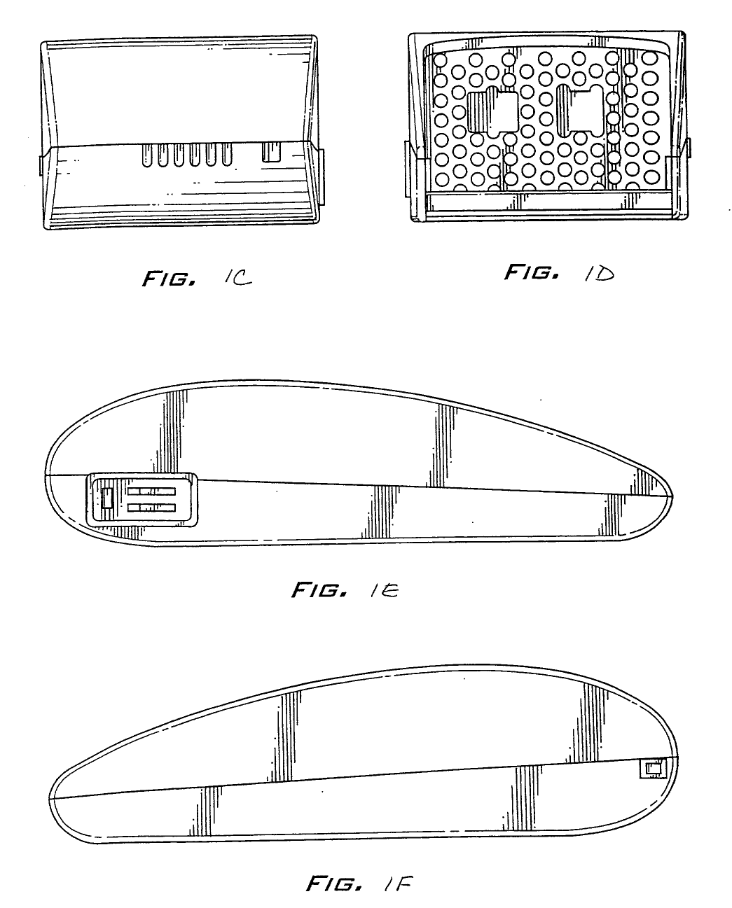

The fully assembled foot dryer 10 is illustrated in FIG. 1A as including an upper unit 12 and lower unit 14. FIGS. 1B, 1C, 1D, 1E and 1F show, respectively, the top view, rear view, front view, left side view, and right side view of the foot dryer 10. The upper and lower units 12 and 14 may be removably secured together to facilitate access to internal details for cleaning, replacement and repair. The upper and lower units 12 and 14 define a forward cavity or space 16 for receiving a foot. An opening 18 is generally positioned at the front end 19 of the foot dryer 10 to access the forward cavity 16. The forward cavity 16 and opening 18 may be adapted to receive one foot or both feet of a user.

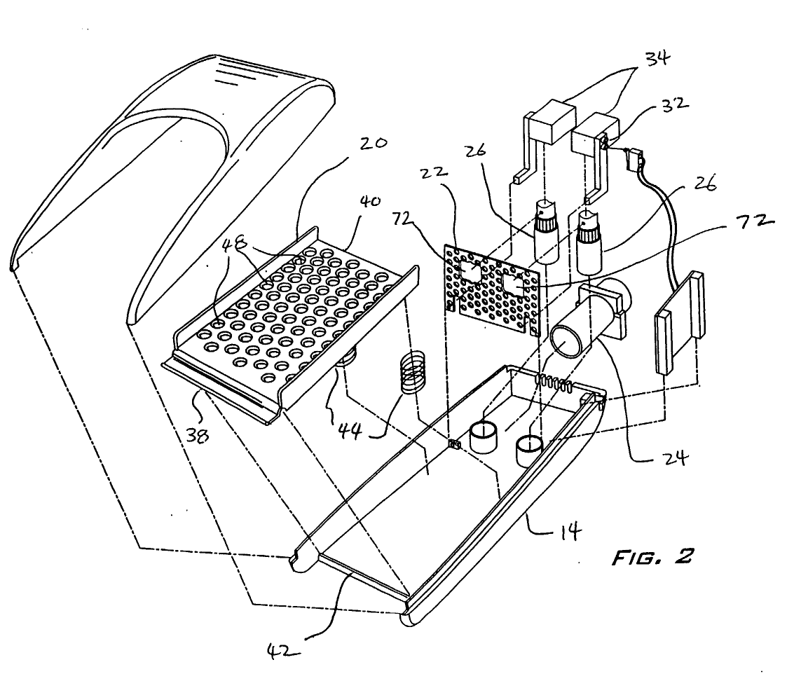

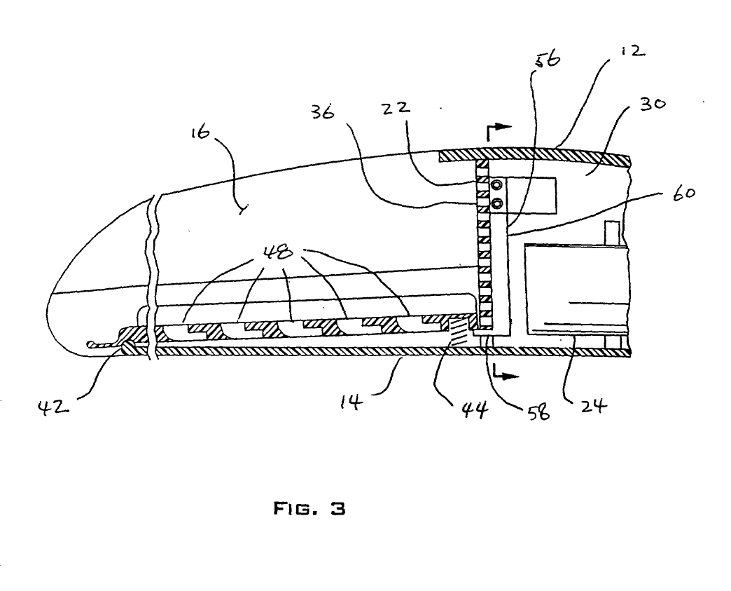

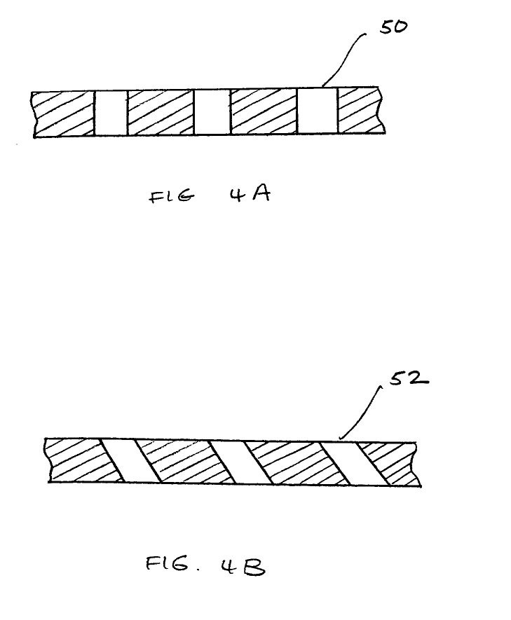

FIG. 2 illustrates an exploded view and FIG. 3 illustrates a cross-sectional side view of the foot dryer 10. The footrest 20 is disposed within the forward cavity 16. A partition 22 is disposed adjacent to the footrest 20 separating the forward cavity 16 and a rear cavity 30. The rear cavity 30 is defined by partition 22, upper and lower units 12 and 14 as illustrated in FIG. 3. The rear cavity 30 houses internal details including a blower 24, liquid holders or dispensers 26, actuators 32, 34 and other details to be described in more detail below.

The blower 24 mounts to the lower unit 14 in the rear cavity 30 as illustrated in FIG. 3. The blower 30 is oriented such that airflow generated will be directed to the forward cavity 16. The partition 22 includes a plurality of openings 36 to facilitate airflow into the forward cavity 16. The partition 22 also advantageously prevents the foot from touching the blower 24 or other details housed in the rear cavity 30.

A heater (not shown) may be coupled to the blower 24 to provide heated airflow to the forward cavity 16 for enhancing foot drying. For example, a coil heater or any device suitable for heating moving air may be disposed inside or outside of the blower 24. Additionally, a thermostat (not shown) may be coupled to the heater 40 for controlling the temperature of the air under pressure.

The thermostat may be a manually controlled thermostat or a smart thermostat that automatically controls the temperature of the air under pressure. Using a manual thermostat, the user can adjust the thermostat to cause the temperature of the air, which is delivered under pressure to the forward cavity 16, to a desired temperature.

Using a smart thermostat, a cycle of controlled and temperature regulated air may be delivered to the foot. For example, the blower may automatically deliver ambient temperature to the forward cavity 16 during a first period of time. During a second period of time the temperature of the air under pressure may be increased to a higher temperature. Finally, during a third period of time, the temperature of the air under pressure may be decreased again to ambient temperature. In this controlled manner, the temperature of the air under pressure may be maintained at a safe level to prevent the feet and toes of the user from being overly heated.

An electrical cord with an electrical socket male plug preferably with a ground (not shown) plugs into a source of electrical power for supplying the blower 24 and the heater with electrical energy. The electric cord may be connected to a rechargeable battery pack (not shown) housed within the dryer 10. When not in use, the electric cord may recharge the battery pack allowing the dryer 10 to have all the advantages of a portable, battery-powered device.

Referring to FIGS. 2 and 3, the footrest 20 is preferably elongated to accommodate a foot or feet and includes a proximal end 38, and a distal end 40. An elevated member 42 of the lower unit 14 supports the proximal end 38 of the footrest 20. The distal end 40 is elevated with a pair of springs 44 such that the footrest 20 is inclined at an upward angle. The additional distal end 40 elevation provided by the springs 44 relative to the proximal end 38 when the footrest 20 is unloaded is preferably half an inch. However, even when the springs are loaded, the footrest 20 arranged in this manner remains elevated leaving a cavity underneath the footrest 20 that is in fluid communication with the blower 24 at all times. Hence, with the configuration above described, airflow from the blower 24, not only flows over the footrest, but also flows underneath the footrest.

Though a pair of springs 44 is illustrated to support the distal end 40 of the footrest 20, a single spring and/or a rigid stopper or other means to elevate the distal end 40 may be used. For example, as illustrated in FIG. 8, a single spring 45 may be disposed centrally under the distal end 40 and rigid stoppers 47 may be disposed on both sides of the spring 45 to prevent the spring from bottoming out and losing its resiliency. However, a double spring configuration has been found to provide balanced support and comfort when the user positions his or her foot on the footrest 20.

Still referring to FIGS. 2 and 3, the footrest includes a plurality of apertures or perforations 48 that allow the air flowing underneath the footrest to travel upward to the upper portion of the footrest. The perforation 48 extends downward and is oriented in the direction of the airflow underneath the footrest and provides a gradual and smooth flow path for the airflow underneath the footrest to travel upwards. Though contoured perforations 48 are shown, a straight through hole 50, as illustrated in FIG. 4A, an inclined hole 52, as illustrated in FIG. 4B, or other orifice design which provides fluid communication between the upper portion of the footrest and the underneath portion of the footrest may be used. However, a perforation having a gradual and smooth flow path reduces turbulence and vibration effects caused by the upward flowing air.

Regardless of the perforation configuration selected, the perforations are preferably sufficiently large to allow air under pressure to flow upward through them and evaporate moisture on the bottom of the user's feet. The perforation on the footrest may be created by molding, machining or other suitable manufacturing method commonly used for such configurations. By configuring the footrest 20 as above described, an efficient distribution of heated air over the entire upper and lower portions of the foot is provided for effective drying.

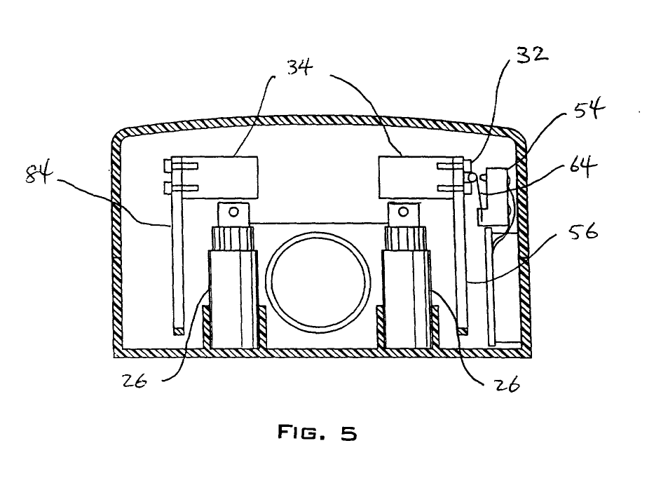

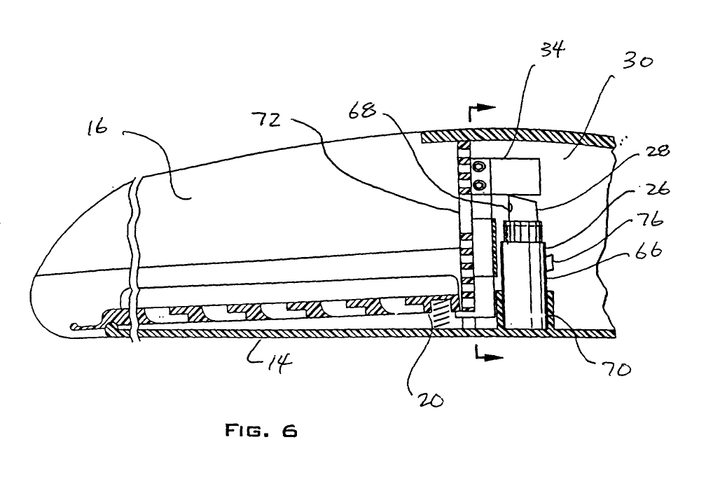

Referring to FIGS. 3 and 5, the footrest 20 functions as a switch plate when coupled to an electric switch 54 by a lever 56 thereby allowing the user to activate and deactivate the dryer 10 by maneuvering the footrest. For example, the lever 56 may include a base member 58 and an arm 60 generally configured to form the shape of a letter “L.” The base member 58 is positioned underneath the distal end 40 of the footrest 20. Referring to FIG. 5, adapted at the top of the lever arm is an actuator 32 in the form of a screw that interfaces with the electric switch 54. The electric switch 54 interface to the actuator may be, for example, an electrically conducting spring member 64.

Operation of the footrest 20 functioning as a switch plate will now be described. Initially, the footrest 20 is in an unloaded position. When the user places one or both feet on the footrest 20 and exerts sufficient downward force thereon, the distal end 40 of the footrest 20 moves to a first position where the base member 58 is displaced downward such that the actuator 32 presses against the spring member 64 to close the electric switch 54. Closing the switch 54 establishes an electrical signal path between the source of electrical power (via the electrical cord or rechargeable battery pack) and the blower 24 and the heater. The blower 24 and the heater respond to the electrical power signal by supplying to the forward cavity 16 with airflow to dry the user's feet in a safe and efficient manner. When the foot or feet of the user are dry, the user removes his or her foot or feet off the footrest 20 releasing the downward force on the footrest 20. Once the downward force on the footrest 20 is removed, the pair of springs 44 pushes the footrest to its original unloaded position thereby moving the electric switch 54 to the normally open position and deactivating the blower 24 and heater.

Though an electric switch 54 having a spring member 64 is illustrated, it is envisioned that a spring-loaded toggle switch or any other electric switch suitable for closing and opening an electrical connection using a mechanical motion similar to the footrest 20 displacement as described above may be employed in the foot dryer 10 according to the present invention.

Also, though simultaneous activation of the blower 24 and the heater has been described above, the blower 24 and the heater according to the present invention may be independently controlled. For example, the heater may simply have a separate switch that may be controlled manually. Alternatively, separate switches for the blower 24 and heater may be arranged whereby mildly depressing the footrest 20 from the unloaded position to the first position activates only the blower 24, and depressing the footrest 20 further, for example, by applying greater force, to a second position activates the heater. The heater may be deactivated when the footrest 20 is returned to the first position and the blower may be deactivated when the footrest is returned to the unloaded position.

Referring to FIG. 2 the foot dryer 10 may be used to bathe the user's feet or toes, or both, with a mist of a moisture inhibiting or fungus inhibiting agent that is dispensed from liquid holders or dispensers 26. Applying a solution containing a suitable anti-fungal agent advantageously helps to prevent foot fungus formation (e.g. athlete's foot). Alternatively, the solution may contain a fragrance, or an antibacterial or other anti-microbial agents. By dispensing a liquid rather than powder, the anti-fungal agent for example, may be applied onto the foot even though the foot has not completely dried. Also, by applying liquid, no powdery particles are left on the on the foot or on the foot dryer 10 warranting unnecessary clean up.

The liquid dispensers 26 contain the desired liquid to be dispensed. Referring to FIG. 6, the liquid dispensers 26 are disposed adjacent to the footrest 20 in the rear cavity 30 and oriented to dispense the liquid into the forward cavity 16. The partition 22 includes windows 72, 74 to allow for the liquid to enter into the forward cavity 16.

Liquid dispensers 26 may be a detachable independent unit or an integral unit of foot dryer 10. In detachable form, the liquid dispenser 26 may have a reservoir 66 and an outlet 68, as illustrated in FIG. 6. Preferably, the outlet 68 comprises an aerosol or mist generator such as a pressurized propellant aerosolizer, a mechanical pump aerosolizer or other suitable mist generator commonly known and commercially available as spray bottle, sprayers, pumps or squirt bottles.

Referring to FIG. 6, the detachable liquid dispensers 26 are secured to the lower unit 14 in the rear cavity 30. A receptacle embodied as a well 70 may be configured to hold the liquid dispensers 26 in place. Alternatively, the liquid dispensers 26 may be secured to the foot dryer 10 using spring clips, velcro, adhesive tapes, recesses, or other suitable securing means. However, a simple well 70 configuration provides easy access to the liquid dispenser 26 and advantageously keeps the manufacturing costs low, clean up easy and liquid dispenser replacement convenient.

Although the liquid dispensers 26 are shown secured to the lower unit 14, any convenient location will suffice so long as the solution may be dispensed into the forward cavity 16.

The interface between outlet 68 and reservoir 66 may be a simple male/female thread configuration or other suitable fastening configuration which allow separation for filling the reservoir with the desired liquid. Alternatively, the reservoir 66 may have a separate access port 76 for liquid filling purposes.

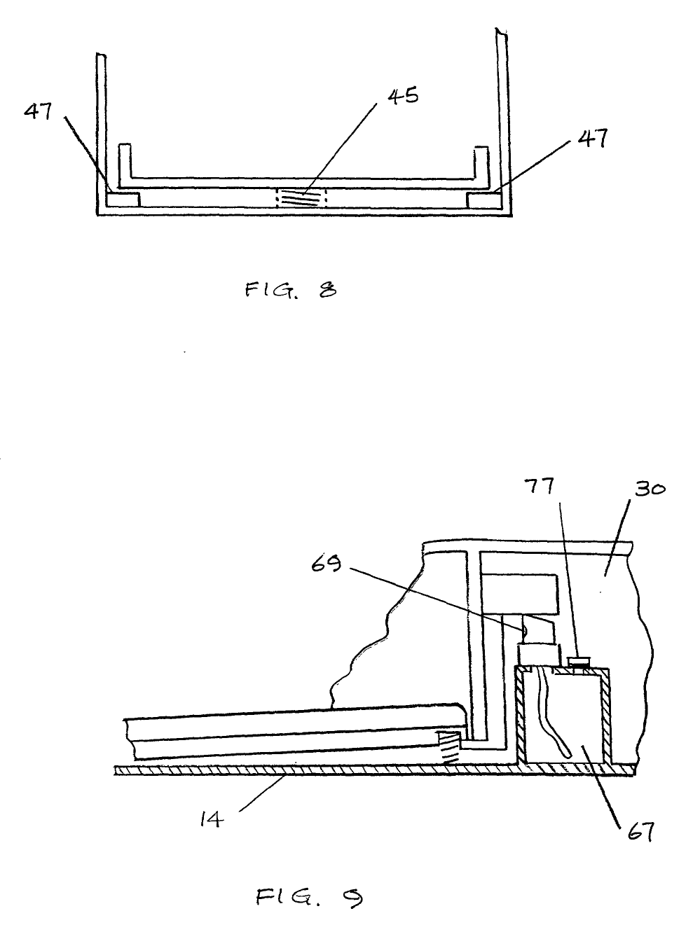

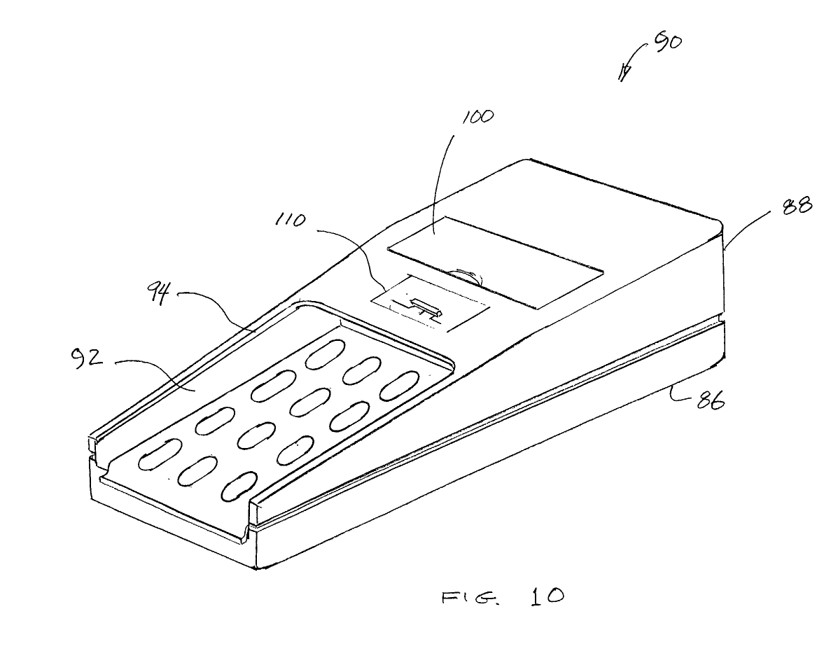

In an alternative embodiment, the liquid dispenser may be integrally connected to the foot dryer housing. Referring to FIG. 9, a reservoir 67 is illustrated integral to lower unit 14 in the rear cavity 30. An outlet 69 preferably having a mist generator is disposed atop the integral reservoir 67 such that the liquid solution contained therein may be aerosolized and dispensed into the forward cavity 16. For refilling purposes, the outlet 69 may be removable from the integral reservoir 67 or an access port 77 may be adapted to the integral reservoir.

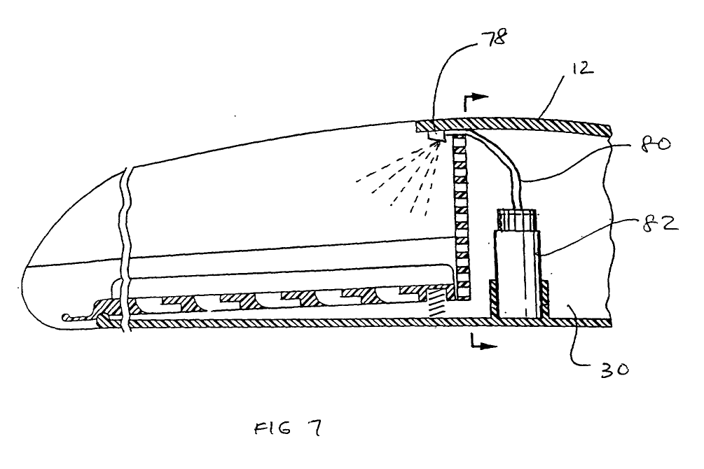

Referring to FIGS. 6 and 9, although the outlets 68, 69 are shown attached to the top of the reservoir 66, it is not necessary to be so configured. The outlet may be remote from the reservoir and connected to the reservoir by a tube made of plastic or other suitable material for transferring liquid. By having a remote outlet, the outlet may be positioned where space is limited while the reservoir may be located where space is available. For example, to dispense the solution from above the footrest 20, a remote outlet 78 may be mounted on the upper unit 12 as illustrated in FIG. 7. A transfer tube 80 connects the remote outlet 78 to a reservoir 82. The reservoir 82 may be mounted to the lower unit 14 or located under the footrest or other convenient location to hold greater amount of liquid. Furthermore, a second tube connecting the liquid dispenser to an external liquid source may be used to provide continuous supply of liquid for dispensing.

Additionally, although two liquid dispensers are illustrated, the apparatus according to this invention may have less or more dispensers. However, employing multiple dispensers provide for greater and effective solution application on the user's foot. Additionally, each dispenser may contain different solution allowing for application of multiple agents or ingredients.

Referring to FIG. 6, the footrest 20 may function as a switch plate to dispense liquid when coupled to a lever 84 and an actuator 34. For example, a foot dryer 10 according to the present invention using a liquid dispenser having an aerosolizer outlet will be described below. Generally, an aerosolizer liquid dispenser dispenses liquid when a downward force is applied (e.g., a finger pushing down) on a trigger mechanism. The actuated trigger mechanism may pressurize the liquid in the reservoir or open an internal valve to release pressurized liquid to exit through a pin-sized opening at the outlet to form mist.

Referring to FIGS. 5 and 6, the footrest 20 is coupled to an actuator 34 that is disposed over the trigger mechanism 28 of the aerosolizer liquid dispenser 26. The actuator 34 is secured to the top of lever 84, which includes a base member 46 that is positioned below the distal end 40 of footrest 20.

In operation, a mild depression on footrest 20 moves distal end 40 from an unloaded position to a first position which activates the dryer and/or heater as previously described. Lever 84 may be configured such that when the footrest 20 is in the first position, actuator 34 is not yet engaged with the trigger mechanism 28 of the liquid dispenser 26. When footrest 20 is depressed further, the distal end 40 moves from the first position to a second position which causes the actuator 34 to press down on the trigger mechanism 28 of the liquid dispenser thereby dispensing liquid into the forward cavity 16. The user may repeat this motion of pressing down on the footrest 20 i.e., moving the distal end of the footrest from a first position to a second position, as many times as desired, to receive multiple deliveries of the liquid.

Although a general aerosolizer liquid dispenser has been described above, the foot dryer of the present invention may be adapted to use commercial pump or spray liquid dispenser products containing the desired liquid. A commercial pump or spray conveniently encompasses in a self-contained single unit an aerosolizer and a liquid supply. When the content of the commercial pump or spray is used up, it is conveniently discarded and replaced. The well 70 on the lower unit 14 may be sized to accept varying sizes and the dispenser actuator 34 may be adjusted to accommodate different heights of the various commercial liquid dispenser products available.

Additionally, the foot dryer according to the present invention may be used to dispense liquids from multiple dispensers concurrently or separately. For example, to dispense liquid concurrently from two dispensers, two actuators 34 and two levers 84 may be coupled to the footrest 20. The two actuators 34 may be disposed over the trigger mechanism of two liquid dispensers whereby applying a single downward force on the footrest 20 dispenses liquid from both dispensers.

In another embodiment, separately dispensing liquids from two dispensers may be achieved by a footrest comprising two independent members where the first member is coupled to a first liquid dispensing actuator, and the second member is coupled to a second liquid dispensing actuator. The left foot may be used to apply force onto the first member to dispense liquid from one liquid dispenser, and the right foot may be used to apply force onto the second member to dispense liquid from a second liquid dispenser. By configuring the foot dryer as described above, liquids contained in two dispensers may be dispensed separately.

Similarly, the footrest may concurrently or separately control a blower and a liquid dispenser. For example, the first independent member of the footrest may be coupled to a liquid dispenser actuator and the second independent member of the footrest may be coupled to a blower switch thereby allowing separate control over the blower and the liquid dispenser.

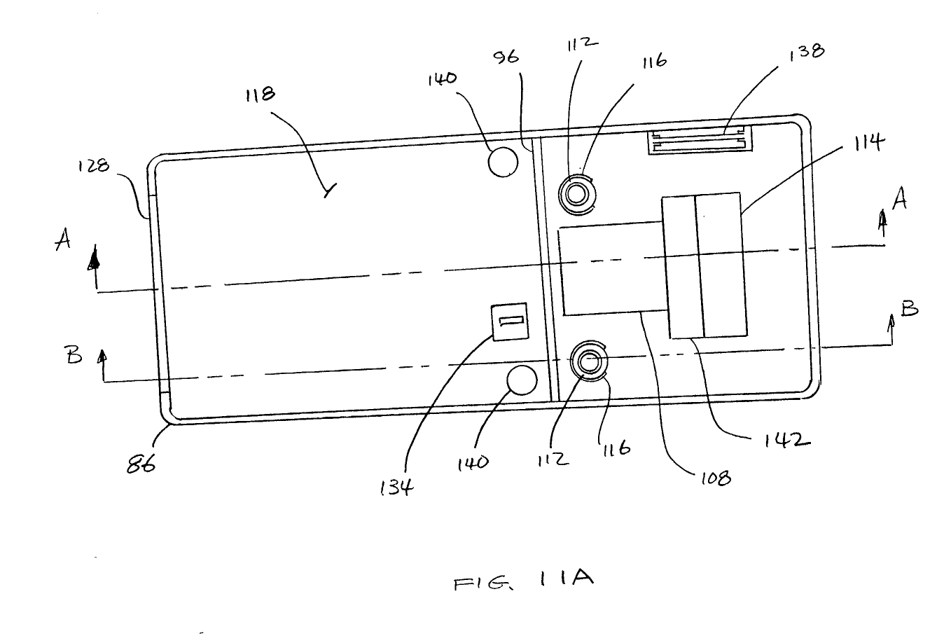

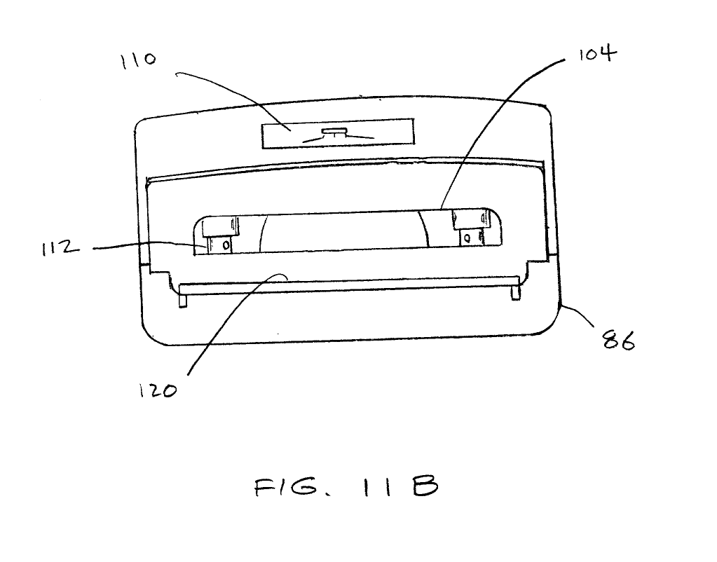

FIGS. 10-21, show another embodiment of a foot dryer 90 constructed according to the present invention. Turning to FIGS. 10 and 11A, foot dryer 90 comprises a lower unit 86, having a generally rectangular base 118 for supporting from below an upper unit 88. The lower and upper units 86 and 88 are secured removably together to define a forward cavity 92 having an opening 94. A partition 96 disposed within the forward cavity 92 functions to separate the forward cavity 92 and the rear cavity 98. An access lid 100, covering passage 102, is disposed conveniently on a top portion 132 of the upper unit 88 for the user to access the rear cavity 98 for removing or replacing liquid dispensers as will be discussed in more detail below.

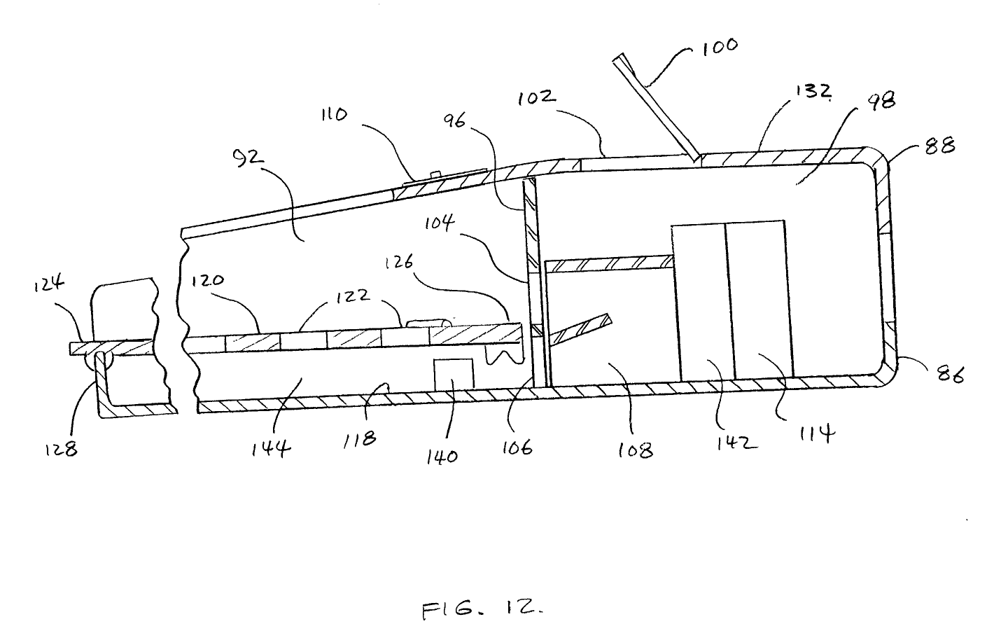

FIGS. 11B and 12 illustrates a cross-sectional side view of foot dryer 90. A footrest 120 is disposed within the forward cavity 92. The rear cavity 98 is defined by partition 96, upper unit 88 and lower unit 86. To surround the user's foot or feet with a uniform flow of warm or heated air under pressure, foot dryer 90 includes a blower 114 and heater 142 disposed within the rear cavity 98. Base 118 of lower unit 86 supports the blower 114 and heater 142 from below. The blower 114 and the heater 26 are in fluid communication with one another and in fluid communication with the forward cavity 92 and lower cavity 144. The lower cavity is defined by the partition 96, base 118 of the lower unit 86 and footrest 120. The partition 96 includes openings 104, 106 to facilitate airflow to the forward and lower cavities. A flow guide 108 may be disposed adjacent to the heater to split and direct the pressurized air from the blower 114 through the partition openings 104, 106.

Though two partition openings 104, 106 and flow guide 108 is shown to distribute pressurized air into the forward and lower cavities, other configurations may be suitable for this purpose. For example, a single large opening in the partition without a flow guide, or a partition having two openings without a flow guide may also be used to direct the airflow into the forward and lower cavities.

A thermostat (not shown) coupled to the heater 26 enables the user to control the temperature of the air under pressure. A control for the user to adjust the thermostat may be disposed conveniently on the top portion 132 of the upper unit 88. The thermostat may be a manually controlled thermostat or a smart thermostat that automatically controls the temperature of the air under pressure as already described.

In another embodiment of the present invention, the foot dryer is configured with a control panel 110 coupled to a thermostat to provide a number of preset temperature settings. To illustrate, a control panel 110 including three settings (e.g. no heat, low heat and high heat) may be located on top portion 132 of the upper unit 88 as shown in FIG. 12. Before activating the foot dryer, the user selects one of the available preset settings. When the foot dryer 90 is activated, as will be described in more detail below, a comfortable and effective pressurized heated air, as selected by the user, is circulated about the user's feet. By presetting the temperatures of the heated air to be delivered at a safe temperature, injury to the user is avoided while ensuring effective foot drying.

As best seen in FIGS. 11A and 13, foot dryer 90 also includes two liquid dispensers 112. The liquid dispensers are disposed in the rear cavity 98 in wells 116. As will be explained hereinafter in greater detail, the liquid dispensers 112 facilitate bathing the user's foot or feet with a fine mist of, for example, fungus inhibiting liquid. In this regard, after the foot dryer 90 applies a mist of fungus inhibiting liquid onto the user's foot or feet, the dryer 90 simultaneously or at about the same time circulates heated or unheated pressurized air (as selected by the user) to dry the user's foot or feet. In this manner, the foot dryer 90 promotes healthy, fungi free feet.

To enable the user to activate and deactivate the foot dryer 90 to dispense the liquid from the liquid dispensers 112 and to cause pressurized air to circulate about the forward cavity 92, the foot dryer includes a footrest 120. The footrest 120 serves to support the user's foot and also as a switch plate to activate and deactivate the foot dryer. Footrest 120 includes a proximal end 124 and a distal end 126. As shown in FIG. 12, the proximal end 124 of the footrest 120 pivotally mounts on a support member 128 disposed on the lower unit 86, wherein support member 128 is elevated from the base 118 of the lower unit 86. A pair of actuator arms 130 coupled to liquid dispensers 112 elevates the distal end 126 of the footrest. In the unloaded state, the footrest 120 is inclined with the distal end 126 slightly elevated from the proximal end 124. A switch 134 having a depending spring member 135 is disposed underneath the footrest 120 generally at the distal end 126. In this manner, when a sufficient amount of force is applied downwardly on the footrest 120, the footrest 120 pivots at the proximal end 124 and the distal end 126 moves downwardly to cause the spring member 135 to compress and engage with an actuator 136 forming part of the switch 134. Sufficient compression of the spring member 135 establishes an electrical signal to be sent to the control circuit 138, which activates the blower and/or the heater. Although a switch 134 including a spring member 135 and actuator 136 is generally described, any suitable single stroke switch which may be triggered by the general downward motion of the footrest distal end 126 as described above may be used. The foot dryer may also be configured with a manual main power switch (not shown), that enables the control circuit 138 and switch 134 to activate the blower and/or the heater, so as to prevent inadvertent activation of the foot dryer.

Though a footrest 120 pivoting about the proximal end 124 is shown, those skilled in the art will recognize that pivoting the footrest about its distal end 126 may readily be accomplished without deviating from the present invention. In such a configuration, an elevated member would support the distal end and the switch would be disposed underneath the proximal end of the footrest.

From the foregoing, those skilled in the art should understand that the user controls the temperature of the air being delivered to the forward cavity 92 by selecting the available settings as provided on the control panel 110. The control panel 110 is coupled to the control circuit 138. The control circuit 138, disposed in the rear cavity 98, controls the blower and the heater. Once the user selects a preset setting on control panel 110, loading the footrest 120 triggers the switch 134 which sends an electrical signal to the control circuit 138. The control circuit then commands the blower 114 and the heater 142 to generate pressurized airflow at the desired temperature.

The control circuit 138 may advantageously control other parameters. For example, the control circuit 138 may be programmed to control the duration in which the blower and heater operate. The pressure or the rotational speed generated by the blower may also be controlled to have, for example, low and high setting. In this manner, the foot dryer 90 may include a control panel having a series of preset settings for the user to select from, i.e. temperature (ambient, low and high); pressure (low, high); and duration (twenty seconds, forty seconds). Alternatively, the settings on the control panel 110 may be limited to three combined settings, i.e. ambient temperature at low pressure; low temperature at high pressure; and high temperature at high pressure, with each having a twenty second duration. In still yet another variation, the control circuit 138 may be programmed so that once the switch is activated, the twenty second duration of the heated airflow does not reset when the user disengages/engages the switch during the airflow period. In this way, even if the user inadvertently lifts, taps or repositions her foot causing the switch to disengage and engage, unwanted extended heated airflow will not result.

Aside from serving as a switch plate, footrest 120 supports the user's foot while the foot is being dried. Footrest 120 includes perforations or apertures 122 which are sufficient in size and number to allow air under pressure to facilitate drying the user's foot or feet from below. As described above, the proximal end 124 and distal end 126 of the footrest 120 are elevated. The elevation of the footrest 120 from the base 118 of the lower unit 86 defines the lower cavity 144. Referring again to FIG. 12, lower cavity 144 is in fluid communication with the blower 114 and heater 142 through opening 106 of partition 96. Bumpers 140, advantageously disposed underneath the distal end 126 of the footrest 120 ensures that even when the footrest 120 is loaded, the footrest 120 remains elevated. In this manner, pressurized airflow from the blower 114 can travel into the lower cavity 144 and through the apertures 122 of the footrest to surround the user's foot for effective drying.

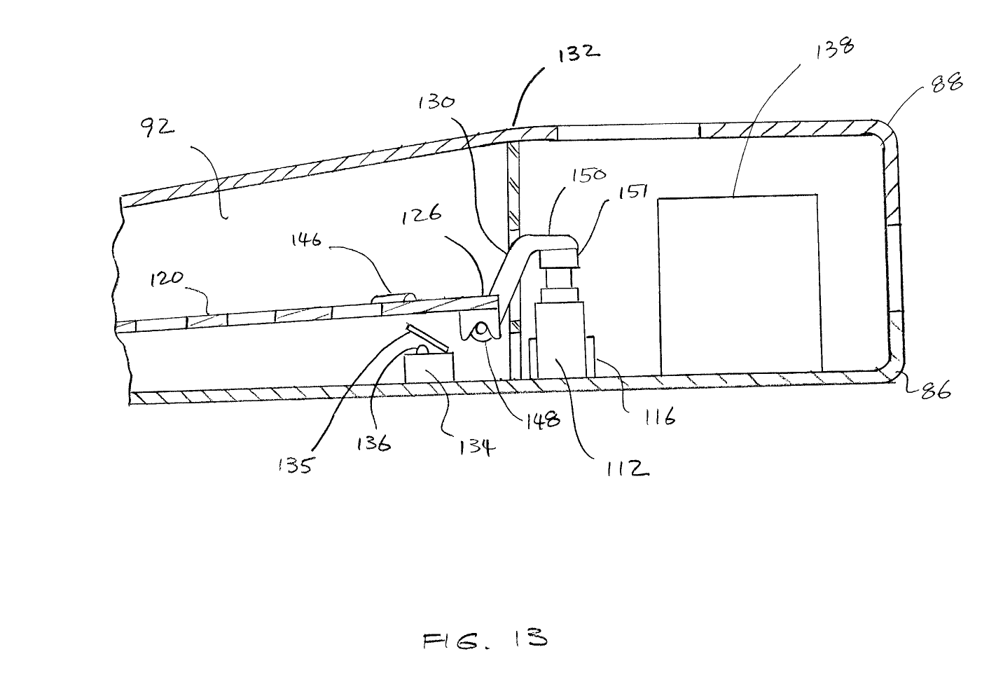

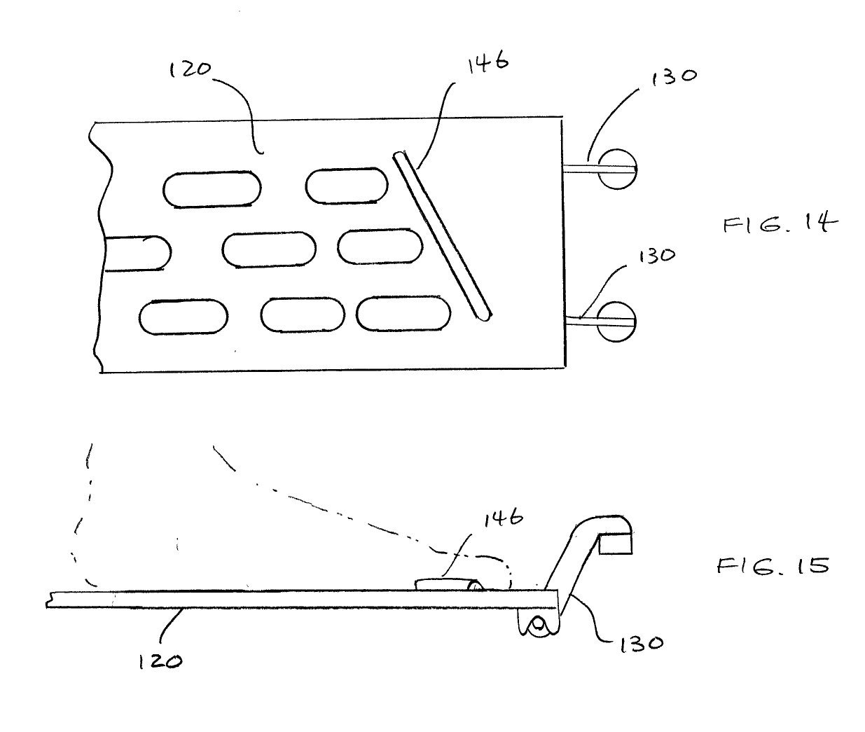

As illustrated in FIGS. 14 and 15, footrest 120 may also include a riser 146 which depends approximately 0.125 inch from the face of the footrest, approximately 0.125 inch wide and extends substantially across the footrest 90 at approximately 30°. The riser 146 comfortably fits between the user's toes and the contour of the ball of the user's foot, and provides the user a tactile guide to correctly position her feet on the footrest within the forward cavity to receive the pressurized heated air and fungus inhibiting liquid.

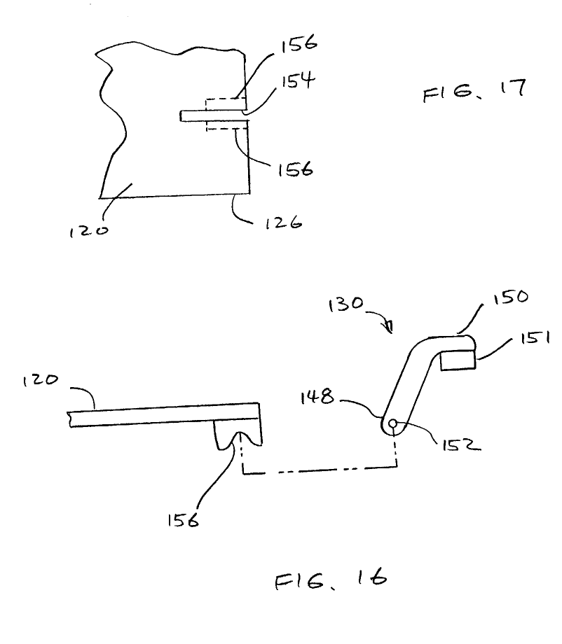

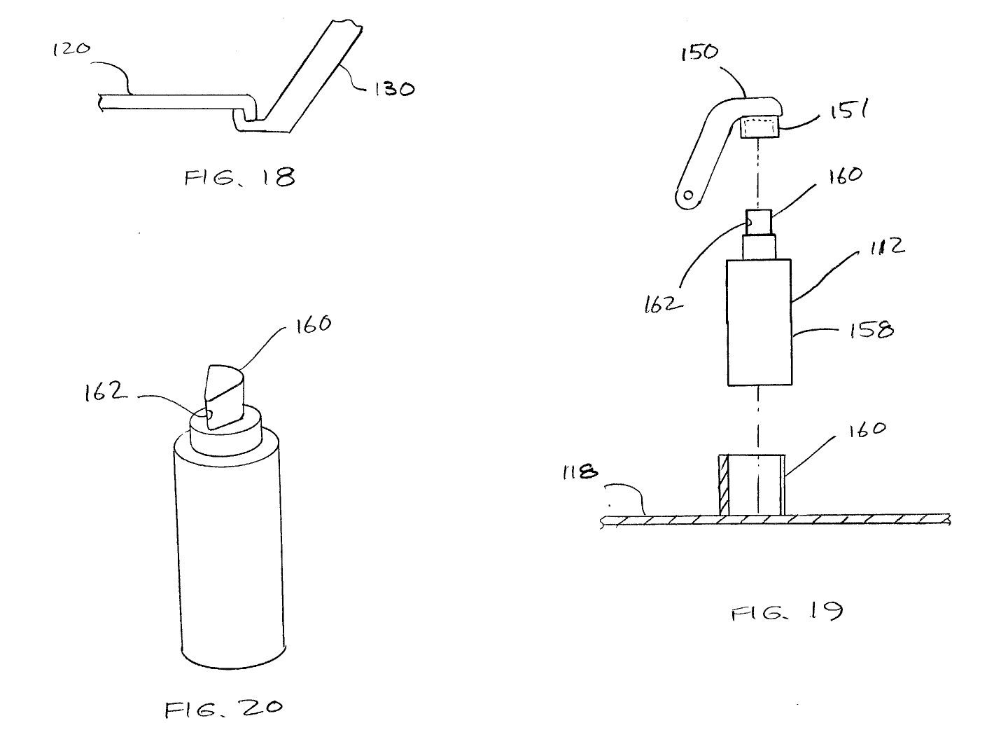

Referring to FIGS. 13-15, the pivotal downward motion of the footrest 90 as described above also causes liquid to be dispensed from the liquid dispensers 112. A pair of actuator arms 130 supports the distal end 126 of the footrest 90. The length of the actuator arms 130 is selected such that the footrest is inclined with the distal end 126 at a slight upward angle. As illustrated in FIG. 16, the actuator arm includes a base 148 and an upper end 150. The base 148 is adapted to pivotally connect to the distal end 126 of the footrest 120. For example, the base 148 may include pivot pins 152 that fit into a corresponding slot 154 and groove 156 of the footrest 120 as shown in FIGS. 16 and 17. Those skilled in the art should recognize other configurations may be suitable to pivotally adapt the actuator base 148 to the distal end 126. For example, a simple “U” configuration that hooks and supports the distal end from below may be used as shown in FIG. 18.

The upper end 150 of the actuator arm 130, including a cap 151, couples to the liquid dispenser 112. As already described, the liquid dispensers are disposed in wells 116. The liquid dispenser 112 may be a detachable unit including a reservoir 158 and a trigger 160 as illustrated in FIG. 19. The trigger 160 may be spring loaded such that depressing the trigger 160 causes the liquid contained in the reservoir 66 to dispense in an aerosol or mist form through the outlet 162. This type of aerosol or mist generator such as a pressurized propellant aerosolizer, mechanical pump aerosolizer, or other suitable mist generator is commonly known and commercially available as spray bottle, sprayers, pumps or squirt bottles. Cap 151 of the upper end 150 of the actuator arm, having a configuration that generally conforms to the outer contour of the trigger 160, is releasably coupled to the liquid dispenser by fitting over the trigger 160. In this manner, liquid dispenser 112 is detachably secured; supported from below by well 116 and above by the actuator arm's upper end 150 and cap 151.

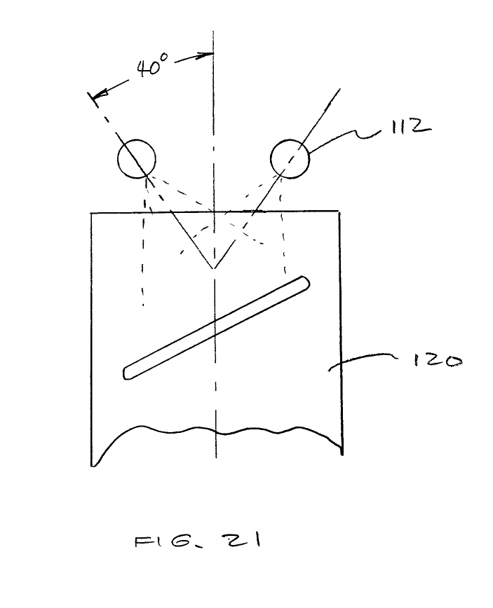

In a preferred embodiment, the shape of the trigger 160 is asymmetric to facilitate orienting the liquid dispenser outlet 162 in the direction of the footrest 120 or the user's foot. For example, the trigger 160 may have a general shape of a circular sector with the outlet 162 generally located at center of the sector as shown in FIG. 20. By configuring the cap 151 of the actuator arm to correspond to the circular sector shape of the trigger 160, the orientation of the liquid dispenser outlet 162 may be controlled as the position of the actuator arm relative to the footrest, and hence the user's foot, may be controlled. Those skilled in the art should recognize that other suitable trigger shapes or devices may be used. For example, a rectangular shape or circular shape with a depending tab is commonly used to orient one component relative to another. Whatever trigger shape is used, in this manner, the actuator arm's cap 151 may be used to properly direct the mist from the liquid dispenser 112.

In a preferred embodiment, the foot dryer 90 includes the two liquid dispensers 112 symmetrically positioned about the user's foot and approximately 3.5 inches apart. The outlet 162 of the liquid dispensers are angled about 40° to the centerline as shown in FIG. 21. It should be noted that less or more liquid dispensers may be positioned at various places. However, a pair of liquid dispensers disposed as described effectively bathes the user's foot with the fungus inhibiting liquid dispensed therefrom.

As described above, the cap 151 of the actuator arm is releasably configured to adapt to the trigger 160. The releasability of the actuator arm from the liquid dispenser trigger facilitates removal and replacement of the liquid dispenser 112 when the liquid within the reservoir becomes empty. The passage 102, covered by access lid 100, disposed on the upper unit 86 is sized sufficiently such that the user may enter the rear cavity 98 to remove and replace the liquid dispensers easily and conveniently. Once the liquid dispenser(s) is replaced, the user can close the access lid 100 and continue enjoying the benefits of the foot dryer 90.

Operation of the foot dryer 90 will now be described. Initially, the user selects one of the preset setting as available on the control panel 110. When the user places one or both feet on the footrest 120 and exerts sufficient downward force thereon, the distal end 126 of the footrest 120 moves downwards which causes the actuator arm 130 to depress the trigger 160 of the liquid dispensers 112. The mist of fungus inhibiting liquid from the liquid dispensers 112 passes through the partition opening 104 to bathe the user's foot or feet located in the forward cavity 92. The same downward displacement of the footrest's distal end 126 activates the switch 134 disposed underneath the footrest 120 which sends an electric signal to the control circuit 138 which in turn activates the heater/blower at the preset temperature, pressure and/or duration setting as selected by the user. In this manner, the foot dryer 90 according to the present invention promotes healthy fungus free feet for the user safely, effectively, and conveniently.

Thus, using the foot dryer 10, 90 the foot or feet of the user are advantageously dried in a fast and efficient manner by effectively distributing heated air over the upper and lower portions of the foot and bathing the foot with fine liquid mist of fungi inhibiting or moisture inhibiting agents to further promote healthy, fungi-free feet. Advantageously, since the fungi-inhibiting agent is delivered using a liquid solution, the agent may be applied even when the user's foot or feet are not completely dried. In addition, any applied liquid solution is easily evaporated leaving only the unseen agent thus requiring less cleaning of the foot dryer.

While preferred embodiments are disclosed herein, many variations are possible which remain within the concept and scope of the invention. Such variations would become clear to one of ordinary skill in the art after inspection of the specification and drawings herein. The invention therefore is not to be restricted except within the spirit and scope of any appended claims.

What is claimed is:

1. A foot drying apparatus comprising:
a frame member for supporting a foot to be dried thereon;
a blower disposed adjacent the frame member;
a first liquid holder disposed about the frame member for dispensing a first liquid onto the foot to be dried.

2. The drying apparatus of claim 1 the first liquid holder having a mist generator.

3. The drying apparatus of claim 1 wherein the first liquid holder is detachable from the drying apparatus.

4. The drying apparatus of claim 3 wherein the first liquid holder may be replaced with a second liquid holder.

5. The drying apparatus of claim 4 the second liquid holder dispensing at least one of the first liquid and a second liquid.

6. The drying apparatus of claim 1 further comprising a second liquid holder for dispensing liquid onto the object to be dried.

7. The drying apparatus of claim 6 wherein the second liquid holder dispenses at least one of the first liquid and a second liquid.

8. The drying apparatus of claim 1 the liquid holder having an outlet.

9. The drying apparatus of claim 8 the outlet disposed adjacent to one end of the frame member.

10. The drying apparatus of claim 8 the outlet disposed above the frame member.

11. The drying apparatus of claim 8 the outlet including a mist generator.

12. The drying apparatus of claim 1 further comprising a heater disposed adjacent the blower.

13. The drying apparatus of claim 1 the frame member including apertures.

14. The drying apparatus of claim 1 the liquid comprising a fungus inhibiting agent.

15. The drying apparatus of claim 1 the liquid comprising a fragrance agent.

16. The drying apparatus of claim 1 further comprising a lever coupled to the footrest for effectuating at least one of activating the blower and dispensing liquid from the liquid holder.

17. The drying apparatus of claim 16 wherein the footrest has an edge, the edge movable to a first position and a second position, the first position actuates the lever to effectuate at least one of activating the blower and dispensing liquid from the liquid holder, the second position actuates the lever to effectuate at least one of deactivating the blower and stop dispensing liquid from the liquid holder.

18. A foot dryer comprising:
a footrest;
a blower disposed adjacent the footrest, the blower coupled to a switch, the switch coupled to the footrest for activating the blower;
a liquid holder disposed about the footrest, the liquid holder coupled to a lever, the lever coupled to the footrest for dispensing liquid onto the footrest.

19. The foot dryer of claim 18 wherein the footrest has an edge, the edge movable to a first position and a second position, the first position operates the switch to activate and deactivate the blower, the second position actuates the lever to dispense liquid.

20. The foot dryer of claim 18 wherein the footrest has an edge, the edge movable to a first position and a second position, the first position actuates the lever to dispense liquid, the second position actuates the lever to stop dispensing liquid.

21. The foot dryer of claim 18 the lever having a first end and a second end, the first end coupled to the footrest, the second end coupled to the liquid holder.

22. The foot dryer of claim 18 the lever having a first end and a second end, the first end coupled to the footrest, the second end coupled to the switch.

23. The foot dryer of claim 18 wherein the footrest includes a first member and a second member, the first member being independent from the second member, the first member coupled to a first switch, the first switch coupled to the footrest for activating the blower, the second member coupled to a second switch, the second switch coupled to the footrest for dispensing liquid.

24. The method of claim 18 the switch disposed beneath the footrest.

25. A foot drying apparatus comprising:
a frame member for supporting a foot to be dried thereon;
a blower disposed adjacent the frame member;
an actuator coupled to the frame member for effectuating at least one of activating the blower and dispensing liquid from a spray bottle.

26. The drying apparatus of claim 25 wherein the actuator is adapted to dispense liquid from a spray bottle having a trigger.

27. The drying apparatus of claim 26 wherein the actuator has a first end and a second end, the first end coupled to the frame member, the second end coupled to the spray bottle trigger.

28. The drying apparatus of claim 25 wherein the actuator has a first end and a second end, the first end coupled to the frame member, the second end coupled to an electrical switch of the blower.

29. Method of drying a foot comprising the steps of:
placing the foot on a footrest;
blowing air about the foot with a blower;
dispensing liquid onto the foot with a liquid dispenser;
controlling the blower and liquid dispenser by maneuvering the footrest.

30. The method of claim 29, blowing air about the foot including depressing the footrest to activate a blower.

31. The method of claim 30, depressing the footrest using the foot.

32. The method of claim 29, dispensing liquid onto the foot by depressing the footrest.

33. The method of claim 32 depressing the footrest using the foot.

34. The method of claim 29, the liquid comprising fungus inhibiting agent.

34. The method of claim 28, blowing the air about the foot including a first period of blowing air at a first temperature and a second period of blowing air at a second temperature.

35. A foot dryer comprising:
a footrest;
a housing having an open drying chamber disposed about the footrest;
a blower contained within the housing;
a holder for dispensing liquid onto the footrest;
wherein the footrest is coupled to the blower and the holder such that maneuvering the footrest activates the blower and dispenses liquid from the holder.

36. A foot drying apparatus comprising:
a footrest movable to a first position and a second position;
a switch disposed underneath the footrest coupled to a blower, wherein the footrest at the first position engages the switch to activate the blower;
a actuator arm including a first end and a second end, the first end coupled to the footrest, the second coupled to the liquid dispenser, wherein the footrest at the first position actuates the actuator to dispense liquid from the liquid dispenser.

37. The foot drying apparatus of claim 36 further comprising a heater disposed adjacent the blower.

38. The foot drying apparatus of claim 36 wherein the footrest includes apertures.

39. The foot drying apparatus of claim 36 wherein the blower activated causes airflow above and below the footrest.

40. The foot drying apparatus of claim 36 wherein engaging the switch activates the blower and heater at a preset speed and temperature for a preset duration.

41. A foot drying apparatus comprising:
a footrest pivotable to a first position and a second position;
a switch disposed adjacent to the footrest and coupled to a blower and heater;
wherein pivoting the footrest to a first position engages the switch to activate the blower and heater at a preset speed and temperature for a preset duration.

42. The foot dryer of claim 41 further comprising an actuator including a first end and second end, the first end adapted to the footrest, the second end adapted to a liquid dispenser, wherein pivoting the footrest to a first position dispenses liquid from the liquid dispenser.
